(19) United States
(12) Patent Application Publication
(10) Pub. No.: US 2001/0049611 A1
(43) Pub. Date: Dec. 6, 2001

(54) Electronically acquiring and distributing insurnace policy data to agent offices

(75) Inventor: Thomas Edward Peach, Marriottsville, MD (US)

Correspondence Address: FITCH EVEN TABIN AND FLANNERY, 120 SOUTH LA SALLE STREET, SUITE 1600, CHICAGO, IL, 606033406

(73) Assignee: ZURICH-AMERICAN INSURANCE COMPANY

(21) Appl. No.: 09/801,753

(22) Filed: Mar. 9, 2001

Related U.S. Application Data
(60) Provisional application No. 60/193,945, filed on Mar. 31, 2000.

(51) Int. Cl. G06F 17/60

(52) U.S. Cl. 705/4

(57) ABSTRACT

A system, method and program product for source point collection of insurance application and contract data. A potential client or a customer contacts an insurance agent, providing sufficient information that includes whatever is necessary to obtain a quote on an insurance policy. The insurance agent passes the client information, preferably over the Internet, to insurance carrier databases on a central system or server. The client data is automatically entered into insurance industry standard forms, such as those promulgated by the Association for Cooperative Operations Research (ACORD), for example. An insurer may accept the application and issue a policy, conveying such information to the requesting agent or return completed forms to the agent. Completed forms may be compressed into a single file which may be transmitted to the requesting insurance agent as e-mail or, may be made available for direct download from the server by the agent. The agent may present the client with a completed insurance policy or pass the completed forms to other agents/insurance companies for review and acceptance.

### CROSS REFERENCE TO RELATED APPLICATIONS

This application claims the benefit of priority under 35 U.S.C. §119(e) to U.S. Provisional application Ser. No. 60/193,945 filed on Mar. 31, 2000.

### DESCRIPTION

### BACKGROUND OF THE INVENTION

1. Field of the Invention

The present invention generally relates to electronic data transportation and storage and more particularly to electronically collecting and sharing of insurance policy application and contract data between insurance carriers and insurance agents.

2. Background Description

Currently the overwhelming majority of property/casualty insurance transactions and a significant percentage of life/health insurance transactions are conducted using the insurance value added network service (IVANS) network. Over 500 firms encompassing over 100,00 users are members of the IVANS network. Participants include individual agents as well as property and casualty companies; life, health and managed care organizations; international re-insurers and brokers; and third party administrators amongst others. These insurance organizations (property/casualty insurance companies, agents, health care and life insurance companies etc.) use IVANS technology to increase sales and improve customer service.

Typically, an agent connects to an insurance company through a systems network architecture (SNA) gateway. The agent places a quote on the main frame system of the insurance company. Then, the next day, the agent dials into the IVANS mail server, downloads the insurance policy and imports related functions.

IVANS, however, which was developed in 1983, is implemented in old technologies and is expensive. Most of the IVANS code is written in older programming languages and is designed for older systems that may not be supported much longer. These old technologies are less dependable and slower than new technologies. Without a total redesign and recompilation of the code for newer systems, IVANS cannot utilize the state of the art technology. Furthermore, most of what is included in IVANS is privately owned by the IVANS network and not available for free use which keeps the cost of the system high.

Therefore, there remains a need for continued support of single data entry and sharing of insurance policy application and contract data, wherein new technologies are used to reconfigure and update the process, improving dependability and timeliness, while decreasing cost. There is a further need to align the process with improved technologies to insure availability of an effective solution.

### SUMMARY OF THE INVENTION

Accordingly, it is a general purpose of the invention to solve the aforementioned needs of the insurance industry including insurance policy application and contract data availability, transmission dependability, management cost and process stability;

It is another purpose of the present invention to improve the insurance policy application and contract process while maintaining process compliance and currency with industry standards;

It is yet another purpose of the present invention to facilitate integration of new and revised agency management systems contemporaneously with availability, coincidentally providing such revised agency management systems for use by insurance agents;

It is yet another purpose of the present invention to eliminate insurance policy application and contract administration bottlenecks.

The present invention is a system, method and program product for source point collection of insurance policy application and contract data. A potential client or a customer contacts an insurance agent, providing sufficient information that includes whatever is necessary to obtain a quote on an insurance policy. The insurance agent passes the client information, preferably over the Internet, to insurance carrier databases on a central system or server. The client information is automatically entered into insurance industry standard forms, such as those promulgated by the Association for Cooperative Operations Research (ACORD), for example. An insurer may accept the policy, conveying such information to the requesting agent or return completed forms to the agent. Completed forms may be compressed into a single file which may be transmitted to the requesting insurance agent as e-mail or may be made available for direct download from the server by the agent. The agent may present the client with a complete insurance policy or pass the completed forms to other agents/insurance companies for review and acceptance.

Thus, insurance carrier data requirements for supporting life cycle insurance policy contract transactions are met. In addition, insurance agent data requirements are met, enabling agents to provide clients with satisfied insurance policy contracts.

Advantageously, the system, method and program product of the present invention reduces redundancy that agents might otherwise meet, providing single data entry ACORD form generation. As a result, the agent's communication costs are minimized, while maintaining data security and integrity. Data is transported quickly and dependably, offering maximum flexibility for agents and insurance companies.

### BRIEF DESCRIPTION OF THE DRAWINGS

The foregoing and other objects, aspects and advantages will be better understood from the following detailed preferred embodiment description with reference to the drawings, in which:

FIG. 1 shows the preferred embodiment source point insurance application and contract data collection system of the present invention;

FIG. 2 shows a flow diagram of the preferred embodiment method.

### DETAILED DESCRIPTION OF A PREFERRED EMBODIMENT OF THE INVENTION

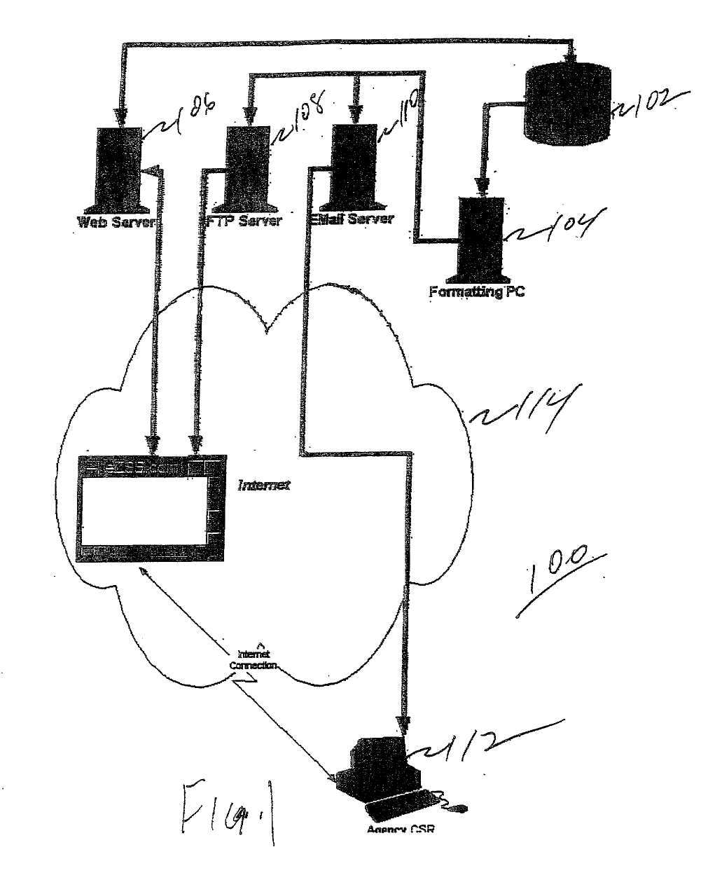

Referring now to the drawings, and more particularly, FIG. 1 shows the preferred embodiment source point insurance policy application and contract data collection system 100 of the present invention. A potential client or a customer contacts an insurance agent, providing sufficient information that includes whatever is necessary to obtain a quote on an insurance policy. As used herein client or customer is intended to refer to any insurable entity which may include for example an individual person, a corporation or other business entity, an association or any other like group. Typically, an insurance agent works interactively with the customer via an Internet connection. The client's data is entered automatically into insurance industry standard forms, such as those promulgated by the Association for Cooperative Operations Research (ACORD), for example. Thus, the client receives a quote in real-time. Alternately, a potential client may contact an insurance agent, providing information during the initial interview which the agent uses to fill out an ACORD type application. The insurance agent passes the quote and related client information, preferably over the Internet, to insurance carrier databases 102 on a central system or main frame server. Optionally, a special purpose interface may be developed for policy application and contract data entry. However, preferably, for seamless use and user friendliness, an ACCORD-like graphical user interface (GUI) screen is provided and the agent enters customer information into the ACORD application. Thus, interface screens comply with requirements of various ACORD sections.

An insurer may accept the policy, conveying such acceptance information to the requesting agent or, declining to accept, return completed forms to the agent. The quote is provided to the agent over the Internet. Initially, underwriting criteria is not requested, but may be invoked if the quoted price and product offering are acceptable to the customer. If, during initial policy application data entry, the customer finds the quoted price acceptable, the customer is presented with a series of questions and automated underwriting rules are initiated in response to the customer's answers. So, it is quite possible that for some clients/customers the agent may never need to contact an underwriter. Completed forms may be compressed into a single file which may be transmitted to the requesting insurance agent as an email attachment or, may be made available for direct download from the server 102 by the agent. Then, upon receipt or download, the agent may present the completed insurance policy contract to the client or, pass completed ACORD forms on to other insurance companies, either forwarding the e-mail, notifying other companies of the URL location or, simply mailing a hard copy forms to other agents/companies.

Accordingly, the preferred embodiment system 100 includes a database 102 located on central main frame or on a formatting computer 104. Access to the database 102 is provided through a web server 106. The system 100 may include a File Transfer Protocol (FTP) server 108 or an e-mail server 110, or both. Remotely connected units 112, such as a personal computer (PC) or a network appliance, are connected over a network 114, such as the Internet, to transfer information through the web server 106, retrieve information from the FTP server 108 or receive e-mail from the e-mail server 110.

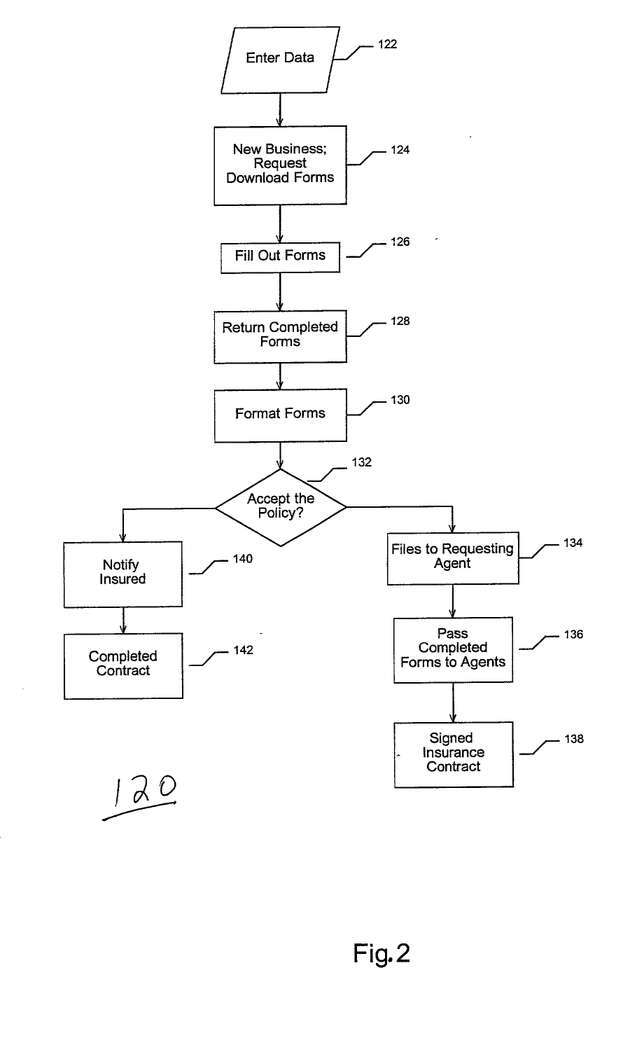

FIG. 2 is a flow diagram of the preferred embodiment method 120. In step 122 an agent connects over the Internet 114 to the web server 106 with a new quote and other information on a potential client. Then, in step 124 the agent issues a new business request and downloads forms through the web server 106 to the agent's PC 112. Next, in step 126 the agent fills out the forms and in step 128 passes the forms back through the web server 106 to the database 102. So, once entered, the information is rated and a premium quote is returned to the agent in real-time. The application and policy data is then sent to formatting system 104 which may be a separate system or may be the same computer wherein the client information database 102 is maintained. In step 130 the formatting system 102 formats application and policy data into industry-standard format, e.g., into completed ACORD forms. Typically, while the agent is inputting information, the information is being rated and formatted into the “download” image. Optionally in step 132 a decision may be made by a designated carrier whether to accept the application and issue a policy. If the policy is not accepted in step 134, the completed forms are provided as uneditable image (e.g., a bitmap), portable document format (pdf) or Joint Photographic Experts Group jpeg) image files.

Then, the download image, which complies with the ACORD electronic standards, is made available for transfer at least until the information is loaded into the agent's Agency Management System (AMS). The completed forms are compressed and combined into a single self-extracting file for ease of use and to minimize the amount of data that must be transferred. Then, if the database server is on a main frame and a separate computer is designated for formatting and compression, the formatting computer 104 uploads the competed ACORD forms to the main frame and the completed forms are stored on the database server 102 and, simultaneously passed to either the FTP server 108 or the e-mail server 110. It should be noted that although the present invention is described, generally, as including multiple connected computers 102, 104, 106, 108 and 110, each having a specific designated task; it is understood that any and all tasks may be designated for a single computer with sufficient capacity and power to perform those tasks without departing from the spirit of the present invention.

Continuing, once the forms are compressed into self-extracting files, in step 134 they are either passed to the FTP server 108 and made available at a private Uniform Resource Locator (URL), or passed to the e-mail server 1 10 and embedded in or attached to an e-mail message. If the self-extracting file is located for download at an URL, then, the URL is communicated to the agent, such as through an e-mail message pointing to the location. If the self-extracting file is embedded in or attached to an e-mail message, the e-mail message is transmitted to the agent. Thus, it may be desirable to include both an FTP server 108 and an e-mail server 110, the self-extracting file size determining the manner in which the compressed forms are provided to the agent, e.g., smaller files being sent as e-mail attachments and larger files being located at an URL on the FTP server.

Upon notification or after a predetermined period, e.g., the next morning, the agent retrieves the self-extracting file, either from visiting the FTP server and selecting the URL to download or, by opening e-mail and downloading the attachment. Then, the agent launches the self-extracting file, thereby, extracting and decompressing the ACORD forms. Preferably, as forms are extracted and decompressed, they are placed in correct directories, automatically. Next, the agent runs an import process to import the images. After the agent connects to the insurer's database and receives or downloads the quote information (via FTP or e-mail), and once the data packet is expanded into ACORD form images, the images are imported into the AMS database. This allows the agent to redistribute the applications to other vendors and to print out the resultant forms for the quote. If, however, the insurance company has decided not to accept the quote, then the agent may print and distribute forms as desired in step 136. In step 138 an insurance company accepts the quote and the contract is completed. If the insurance company has accepted the quote, in step 140, the client is notified and in step 142 the process is complete.

Thus, insurance carrier data requirements for supporting life cycle insurance policy application and contract transactions are met. In addition, insurance agent data requirements are met, enabling agents to provide clients with completed insurance policy contracts.

Advantageously, the system, method and program product of the present invention reduces redundancy that agents might otherwise meet, providing single data entry ACORD form generation. As a result, the agent's communication costs are minimized, while maintaining data security and integrity. Data is transported quickly and dependably, offering maximum flexibility for agents and insurance companies.

Having thus described the invention, it is evident that various modifications and changes may be made without departing from the broader spirit and scope of the invention. Examples and drawings are, accordingly, to be regarded in an illustrative rather than a restrictive sense.

What is claimed is:

1. A system for inputting and collecting insurance information from a plurality of remotely connected agents, said system comprising:
a forms database, said forms database including completed insurance forms;
a network server providing access to said forms database from a plurality of remotely located terminals;
a data transfer server; and
a formatting computer receiving individual client data and formatting forms with said received individual client information, completed forms being provided to said data transfer server.

2. A system as in claim 1 wherein said remotely connected agents are connected over remotely located terminals, said remotely located terminals being connected to said remote server over a network, agents providing client information to said forms database from corresponding ones of said remotely connected terminals.

3. A system as in claim 1 wherein said data transfer server comprises a file transfer protocol (FTP) server, completed insurance applications being stored on said FTP server.

4. A system as in claim 1 wherein said data transfer server comprises an e-mail server, completed forms being e-mailed to a registered originating agent.

5. A system as in claim 1, wherein said e-mail server includes a database, said database including e-mail addresses of registered insurance agents.

6. A system as in claim 1 wherein said forms database further includes client and new business information.

7. A system as in claim 6, said formatting computer comprising:
image generation means receiving client information from said forms database and generating images of insurance policy forms therefrom; and
compression means for compressing insurance policy form images for a single client into a single compressed file, compressed files being stored on said forms database and provided to said data transfer server.

8. A system as in claim 7, wherein said data transfer server comprises:
an e-mail server; and
a file transfer protocol (FTP) server, compressed files below a selected size being e-mailed over said e-mail server to a registered agent, said compressed file being included with said e-mail and, compressed files exceeding said selected size being stored on said FTP server, said registered agent being notified of said stored compressed file location.

9. A system as in claim 7, wherein said insurance policy forms include insurance policy application and contact forms.

10. A system as in claim 1, wherein said client data includes insurance policy application and contract data.

11. An insurance policy application and contract management system for inputting and collecting insurance policy application and contract information from a plurality of remotely connected agents, said system comprising:
a forms database, said forms database including completed insurance policy application and contract forms and, client and new business information;
a network server providing access to said forms database from a plurality of remotely located terminals;
a data transfer server;
a formatting computer receiving client information from said forms database and generating insurance policy application and contract forms therefrom and compressing insurance policy application and contract forms for a single client into a single compressed file, compressed files being stored on said forms database and provided to said data transfer server; and
said plurality of remotely connected terminals being connected to said data transfer server over a network, agents providing client information to said forms database from corresponding ones of said remotely connected terminals.

12. An insurance policy application and contract management system as in claim 11 wherein said data transfer server comprises a file transfer protocol (FTP) server, compressed files including completed insurance applications being stored on said FTP server.

13. An insurance policy application and contract management system as in claim 11 wherein said data transfer server comprises an e-mail server including e-mail addresses of registered agents, compressed files being e-mailed to registered originating agents.

14. An insurance policy application and contract management system as in claim 11, wherein said data transfer server comprises:
an e-mail server; and
a file transfer protocol (FTP) server, compressed files below a selected size being e-mailed over said e-mail server to corresponding registered originating agents, said compressed files being included with said e-mail and, compressed files exceeding said selected size being stored on said FTP server, corresponding registered originating agents being notified of stored compressed file locations.

15. A method of forming and maintaining client contracts, said method comprising the steps of:
a) sending new business information to a formatting computer, said new business information including insurance related information for developing an insurance contract on an entity;
b) automatically formatting said received new business information, formatted new business information being entered into insurance forms;
c) storing formatted new business information in a database;
d) notifying an insurance agent of availability of said stored information; and
e) making said stored information available to said insurance agent, said insurance agent retrieving said stored information.

16. A method as in claim 15 wherein the insurance related information is insurance policy application and contract data formatted into an insurance industry standard format.

17. A method as in claim 16, wherein formatted said insurance related information is embedded into images of insurance industry standard forms.

18. A method as in claim 17 wherein said images are compressed into a single file and stored in said database.

19. A system as in claim 18 wherein the step (d) of notifying said insurance agent comprises sending e-mail to said agent, said compressed file being included with said e-mail.

20. A method as in claim 18 wherein the step (d) of notifying said insurance agent comprises providing said agent with an indication of the location of said compressed file, said compressed file being downloaded by said agent.

21. A method as in claim 17 wherein the step (e) of making said stored information available comprises the steps of:
i) determining whether said compressed file exceeds a selected size; and
ii) when said compressed file does not exceed said selected size, including said compressed file in an e-mail and sending said e-mail to said insurance agent; otherwise,
iii) storing said compressed file, said insurance agent being notified of said stored compressed file's storage location in step (d).

22. A method as in claim 17 wherein said compressed file is a self-extracting file retrieved by said insurance agent to a local computer, files extracted from said self-extracting file being automatically stored in preselected subdirectories on said local computer.

23. A method as in claim 22 wherein after said agent reviews received contract information, said agent distributes said forms to insurance companies to obtain insurance on said entity.

24. A method as in claim 23 wherein said entity is an individual.

25. A computer program product for forming and maintaining insurance policy application and contract information, said computer program product comprising a computer usable medium having computer readable program code thereon, said computer readable program code comprising:
computer readable program code means for sending new business information to a formatting computer, said new business information including insurance related information for developing an insurance contract on an entity;
computer readable program code means for automatically formatting said received new business information, formatted new business information being entered into insurance forms;
computer readable program code means for storing formatted new business information in a database;
computer readable program code means for notifying an insurance agent of availability of said stored information; and
computer readable program code means for making said stored information available to said insurance agent.

26. A computer readable program product as in claim 25 wherein at least one of said insurance forms is in an insurance industry standard format.

27. A computer readable program product as in claim 26, wherein said formatted information is embedded into images of insurance industry standard forms.

28. A computer readable program product as in claim 27 wherein said images are compressed into a single file and stored in said database.

29. A computer readable program product as in claim 28 wherein the computer readable program code means for notifying said insurance agent comprises computer readable program code means for sending e-mail to said agent, said compressed file being included with said e-mail.

30. A computer readable program product as in claim 28 wherein the computer readable program code means for notifying said insurance agent comprises computer readable program code means for providing said agent with an indication of the location of said compressed file.

31. A computer readable program product as in claim 27 wherein the computer readable program code means for making said stored information available comprises:
computer readable program code means for determining whether said compressed file exceeds a selected size when said compressed file does not exceed said selected size, including said compressed file in an e-mail and sending said e-mail to said insurance agent, and otherwise storing said compressed file and said insurance agent being notified of said compressed file's storage location.

32. A computer readable program product as in claim 27 wherein said compressed file is a self-extracting file retrieved by said insurance agent to a local computer, compressed files being extracted from said self-extracting file and automatically stored in preselected subdirectories on said local computer.
